(19) United States
(12) Patent Application Publication
(10) Pub. No.: US 2010/0105018 A1
(43) Pub. Date: Apr. 29, 2010

(54) PASSIVE EDUCATION METHOD AND DEVICE

(76) Inventor: Joseph Andrew Harsh, Fairfax, VA (US)

Correspondence Address: General Counsel, P.C., 6862 Elm Street, SUITE 800, McLean, VA, 22101, US

(21) Appl. No.: 12/260,111

(22) Filed: Oct. 29, 2008

(51) Int. Cl. G09B 3/00; G09B 25/00; G09B 29/00

(52) U.S. Cl. 434/322; 434/428; 434/430; 434/365

(57) ABSTRACT

A method, device, and kit that utilizes tabletop education displays to allow parents and educators to expose the basic fundamentals of Education to subjects throughout the early developmental stages of learning; then, building on the basics, exposes the subject to more complex ideas. It also has the advantage of being customized in the final stage to the interest or strength of a subject. This provides the parents or educator the ability to challenge and develop the subject in its area of interest.

### FIELD OF THE INVENTION

The present invention relates to the field of education and more specifically to the field of leveled education devices.

### BACKGROUND

Tabletops often utilize coverings for various purposes. A primary form of table covering includes table cloths and perhaps table mats proximate to each seat. Table cloths are typically adorned with artistry, often simple repeating patterns or pictures. Exposure to ordinary commercially available table cloths and table coverings may be relaxing, but other goals may be pursued with these common implements.

A family that sits down to meal, whether at a restaurant or within the home, remains for a substantial amount of time. A family meal may include many attention-drawing attributes, such as conversation or simply staring at a plate searching for the fork's next target. Even the most intriguing family meal involves down time; a participant may not be engaged in any of the active meal activities, and instead, stare randomly within the home or at the table. This lack of focus may result from discussion boredom, inattention due to medical issues, or an early finish.

Current educational devices largely ignore this substantial period of time in which one may insert information into a regularly scheduled activity. Therefore, there is a need for educational equipment capable of passively presenting itself to a subject during moments where educational materials are traditionally unavailable for substantial stretches of time, and that is capable of quick, simple, and repeated upgrades to suit the educational abilities of the subject.

### SUMMARY

The present invention is directed to an educational method. The education method allows passive education to be directed at a subject in multiple phases of the subject's development. The method includes indentifying an operational stage at which the subject is currently situated. Operational stages may include any of the following stages: preoperational stage; concrete operational stage; or formal operational stage. An operational tabletop education display is then suggested for/to the subject. The operational tabletop education display includes at least one educational subject matter representation that corresponds to the contemporaneous operational stage of the subject previously identified.

A tabletop education display series is then formulated for the subject. The display series includes a horizontal phase and a vertical phase. The vertical ordering of the series begins with the contemporaneous operational stage of the subject, or in the case of multiple subjects, the lowest identified operational stage. One of the tabletop education educational displays in then placed on a tabletop of the subject for a substantial period of time.

The tabletop education educational displays may be exchanged with another tabletop education display from the horizontal phase of the tabletop education display series. Such exchanges will be for operationally equivalent educational subject matter representations. The tabletop education displays may be replaced with another tabletop education display from the vertical phase of the tabletop education display series. Such replacements will be for more operationally advanced educational subject matter representations.

Therefore, it is an aspect of the present invention to provide an educational method and device capable of passively educating a subject.

It is a further aspect of the present invention to provide an educational method and device capable of leveled education.

It is a further aspect of the present invention to provide an educational method and device capable of education according to established principles of cognitive development.

It is a further aspect of the present invention to provide an educational method and device capable of discreet use.

It is a further aspect of the present invention to provide an educational method and device capable of preventing boredom.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of an embodiment of the process of the present invention.

FIG. 2 is a top, plan view of a tabletop education display of the present invention.

FIG. 3 is a top, plan view of a tabletop education display of the present invention.

FIG. 4 is a perspective view of a tabletop education display of the present invention.

### DETAILED DESCRIPTION

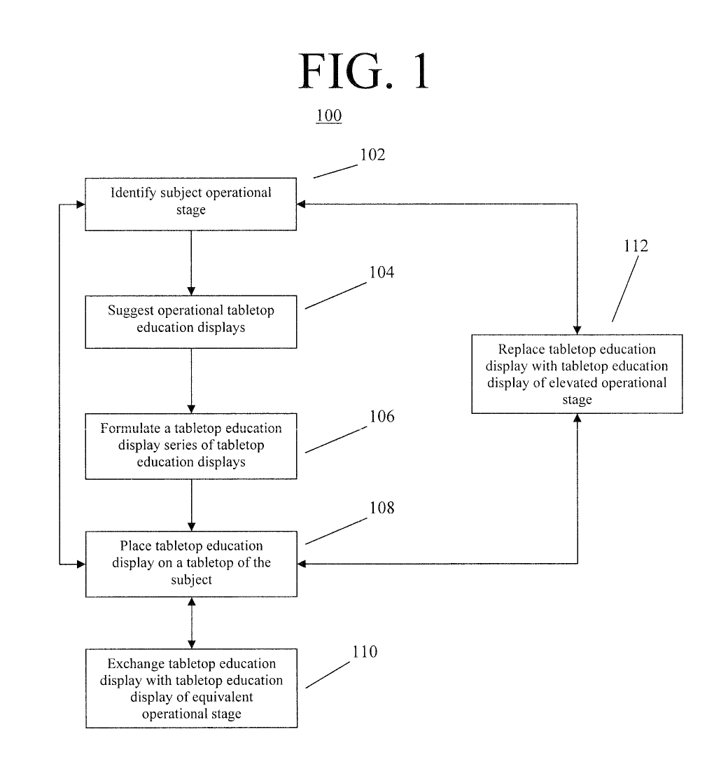

Referring first to FIG. 1, a basic embodiment of the passive education method 100 of the present invention is shown. The passive education method 100 includes identification 102 of the operational stage of a subject. By passive education, it is meant that the present invention is capable of educating a subject at least by virtue of its presence alone, i.e., both actively and through mere presence. The subjects of the present invention may include humans that have cognitively matured beyond the sensorimotor stage of development. Human cognitive development can be divided into four stages: sensorimotor, preoperational, concrete operational, and formal operational.

Sensorimotor stage of operation generally spans the birth of a human to the approximate age of two years. Infants mainly make use of senses and motor capabilities to experience the environment. The present invention screens subjects for development beyond this stage and identifies 102 subjects currently found within this stage of development. The screening portion of the identification includes requesting information related to the experiences and development of the subject or subjects. Such information will be linked to the cognitive development of the subject, and may include questions regarding current education levels, interaction with objects, interaction with people, memory retention, subject verbal strength, and the like. Subjects identified within the sensorimotor stage of development are advised 104 against current use of the present invention or receive suggestions 104 regarding a formulated 106 suitably-delayed schedule for the method 100 of the present invention. Software embodiments of the present invention may return a Boolean value of “false” in the identification step of the present invention.

A second stage of operation is the preoperational stage and typically includes children aged from two to seven. This stage is characterized by the use of symbols, such as language to represent objects. A child is now building a foundation for learning. A third stage of operation is the concrete operational stage where a child begins to think logically and typically includes children aged from four to nine. Operations are associated with personal experiences. Operations are in concrete situation, but not in abstract manipulation. The formal operational stage is the final stage of development. A child in this stage, typically aged eight and beyond, now has the ability to think abstractly. The child can now solve complex and hypothetical problems involving abstract operations.

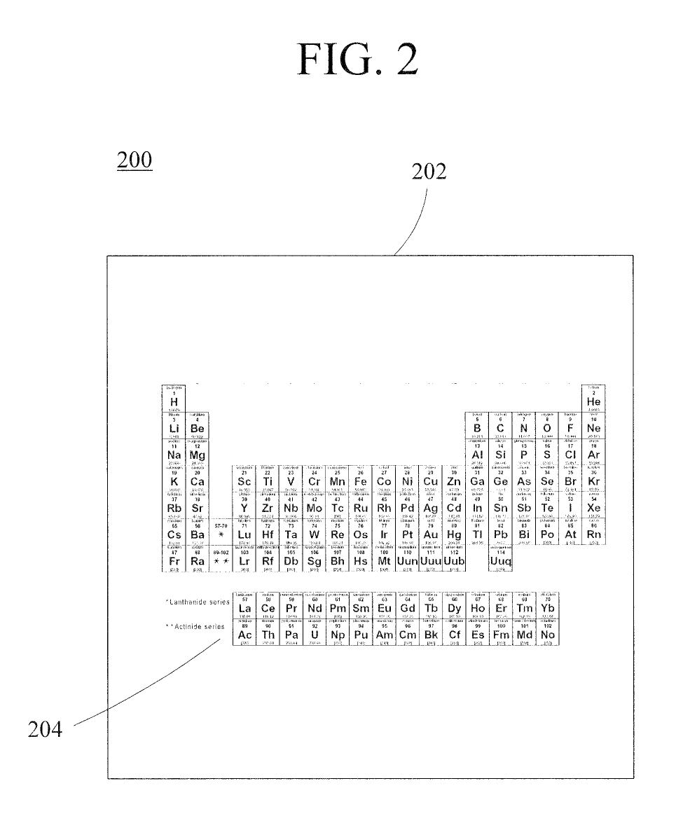

On the basis of the identified 102 operational stage of the subject at the time of processing information related to the stage of development of the subject, the method 100 suggests 104 operational tabletop displays that correspond to the contemporaneous operational level of the subject. Turning now to FIG. 2, the tabletop display 200 of the present invention is a tablecloth with a body 202 bearing at least one educational subject matter representation 204. The educational subject matter representation 204 of the present invention may include any subject matter desired to be learned by the subject. The educational subject matter representation is restricted to those amenable to cognitive digestion appropriate to the operational level of the subject. For tabletop displays 200 corresponding to the preoperational stage of development, numbers, colors and letters are stressed. For tabletop displays 200 corresponding to the concrete operational stage of development, numbers, colors and letters are retained but the representation emphasizes the actual information. By way of example, a world map is appropriate for both the preoperational and concrete operation stages, but the former will emphasize shapes of countries brightly contrasted one to the other while the latter will emphasize cities, rivers, and mountains.

For tabletop displays 200 corresponding to the formal operational stage of development, few limitations apply. Educational subject matter for any stage may include world geography; American geography; chemistry; solar system; music; animal kingdom; engineering; civics; history; English; math; earth science; and the like. The educational subject matter representation 204 is applied to the body 202 of a tabletop cover 200, such as a tablecloth. The tablecloth of the present invention may include any pliable device adapted to fit the dimensions of the sides and upper surface of a table, and is fabricated of any material adapted to deflect or absorb food and drink stains to a degree amenable to simplified table cleaning, e.g. vinyl.

The dimensions of the display 200 includes those of any commercial tablecloth, such that the display body 202 covers the entirety of a table (not shown) upper surface with body portions remaining to overhand side surfaces of a table. A kit of the present invention may include multiple displays 200 of equivalent subject matter representation of leveled operational stages, multiple displays of distinct subject matter representation of equivalent operational stages, or multiple displays of distinct subject matter representation of leveled operational stages.

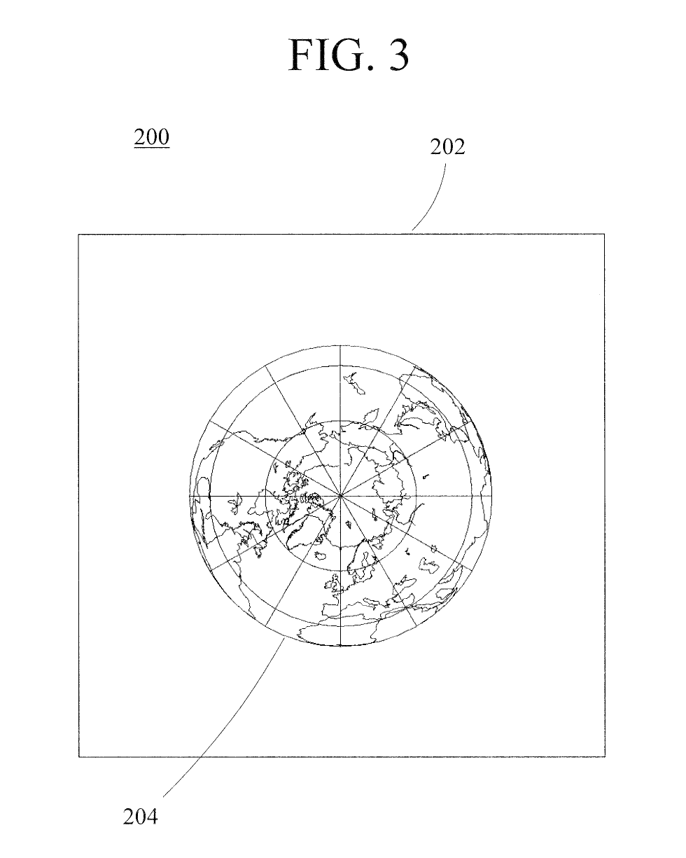

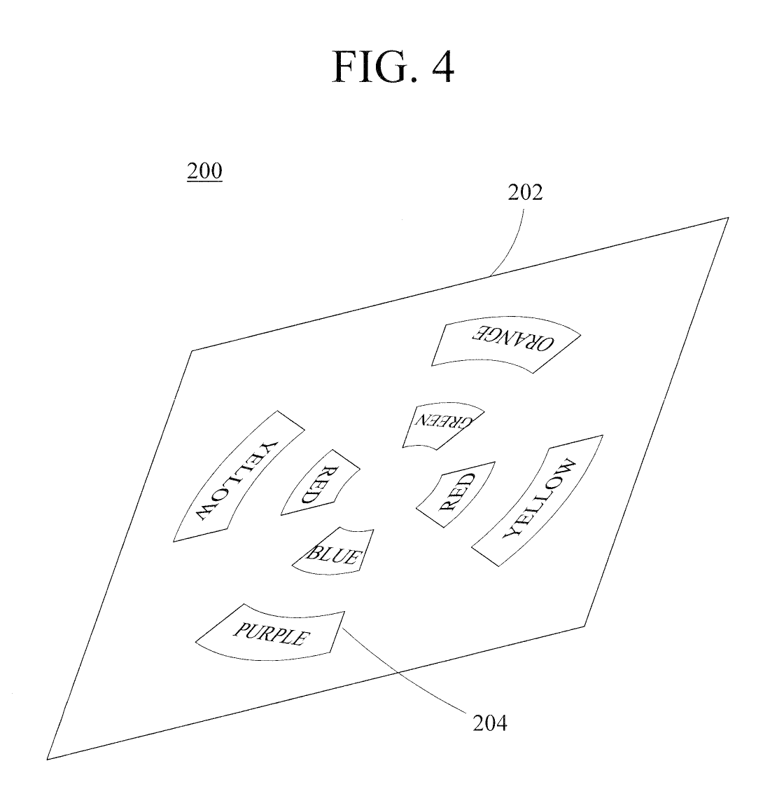

As FIG. 3 shows, the method may include a tabletop cover 200 with a variable vantage point educational subject matter representation 204. The variable vantage point educational subject matter representation 204 utilizes educational subject matter capable of arrangement such that multiple subjects may accurately view the educational subject matter from multiple vantage points. FIG. 4 shows a distorted educational subject matter representation 204. The distorted educational subject matter representation utilizes pre-existing shapes and skews them to suit multiple vantage points of multiple viewers, e.g. concentrically-arranged, curved color blocks. Such an arrangement is advantageous when a tabletop display is crafted for multiple subjects meant to occupy a single table, or when a subject does not have a regular seating arrangement.

Returning to FIG. 1, the method 100 may include formulating 106 a tabletop education display series having a horizontal phase and vertical phase. The tabletop education display series is a customized series of tabletop education displays suited to the current operational stage of the subject and the expected development schedule of the subject. The horizontal phase includes those tabletop displays within the same contemporaneous operational stage of the subject. The vertical phase includes those tabletop education displays more advanced than the contemporaneous operational stage of the subject. For this disclosure equivalent educational subject matters of distinct operational stages are referred to as “leveled,” i.e., either one vertical level above or below. For a subject identified to be in the preoperational stage, for example, a tabletop education display series may include a horizontal phase of tabletop displays having colors and numbers, and a vertical series of multiple tabletop displays for both the operational stages of the concrete operational stage and the formal operational stage.

The tabletop display is the positioned 108 over a table or other frequently occupied furniture surface. The display is used for any period of time desired by the user, until the method 100 of the present invention advises that another tabletop display should be exchanged 110 therefor, until the method 100 of the present invention advises that another tabletop display should be replaced 112 therewith, or other appropriate period of time, such as complete intake of information thereon. The series is ordered from the contemporaneous operational stage of each subject for which the tabletop display device is created. By exchange 110, it is meant that the tabletop display may be removed and a new tabletop display of equal operational stage may be placed 108 on the tabletop of the subject. By replace 112, it is meant that the tabletop display may be removed and a new tabletop display of more advanced operational stage may be placed 108 on the tabletop of the subject. Replacement and exchanges may occur at the whim of the subject or upon readjustment of the tabletop education display series due to an updated identification 102 of the operational stage of the subject.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. An educational method for providing leveled, passive education exposure to at least one subject, said method comprising:
identifying a contemporaneous operational stage of the subject through administration of appropriate developmental questions;
suggesting operational tabletop education displays, having at least one educational subject matter representation, corresponding to said identified contemporaneous operational stage of the subject;
formulating a tabletop education display series having a horizontal phase and vertical phase and ordered from said identified contemporaneous operational stage;
placing at least one of said tabletop education displays selected from said tabletop education display series on a tabletop of the subject, wherein said placed tabletop education display includes a pliable body dimensioned to cover an upper surface of a pre-determined table size and a side surface of said pre-determined table size and said body is fabricated of a material adapted to effectively engage digestible matter;
exchanging at least one of said tabletop education displays from said tabletop education display series with at least one of said tabletop education displays of equivalent operational stage from said horizontal phase of said tabletop education display series.
and
replacing at least one of said tabletop education displays from said tabletop education display series with at least one of said tabletop education displays of elevated operational stage from said vertical phase of said tabletop education display series.

2. The method of claim 1 wherein said identifying step includes identifying said contemporaneous operational stage from a group consisting of:
a preoperational stage characterized by the subject's use of symbols to represent objects;
a concrete operational stage characterized by the subject's use of logical analysis; and
a formal operational stage characterized by the subject's ability to think abstractly.

3. The method of claim 1 wherein said identifying step includes identifying a contemporaneous operational stage of multiple subjects through administration of appropriate developmental questions.

4. The method of claim 3 wherein said suggesting step includes suggesting said operational tabletop education displays, each having multiple educational subject matter representations, corresponding to said identified contemporaneous operational stage of the subjects.

5. The method of claim 3 wherein said suggesting step includes suggesting said operational tabletop education displays with a distorted educational subject matter representation accommodating multiple view perspectives.

6. The method of claim 1 wherein said exchanging step includes an automatic exchange schedule based on said contemporaneous operational stage and a predicted operational stage advancement formulation,

7. The method of claim 1 wherein said replacing step includes an automatic replacement schedule based on said contemporaneous operational stage and a predicted operational stage advancement formulation.

8. An educational method for providing leveled, passive education exposure to at least one subject, said method comprising:
identifying a contemporaneous operational stage of the subject through administration of appropriate developmental questions;
suggesting operational tabletop education displays, having at least one educational subject matter representation, corresponding to said identified contemporaneous operational stage of the subject; and
placing at least one of said tabletop education displays on a tabletop of the subject, wherein said placed tabletop education display includes a pliable body dimensioned to cover an upper surface of an upper surface of a pre-determined table size and a side surface of said pre-determined table size and said body is fabricated of a material adapted to effectively engage digestible matter.

9. The method of claim 8 wherein said identifying step includes identifying said contemporaneous operational stage from a group consisting of:
a preoperational stage characterized by the subject's use of symbols to represent objects;
a concrete operational stage characterized by the subject's use of logical analysis; and
a formal operational stage characterized by the subject's ability to think abstractly.

10. The method of claim 9 wherein said identifying step includes identifying a contemporaneous operational stage of multiple subjects through administration of appropriate developmental questions.

11. The method of claim 10 wherein said suggesting step includes suggesting said operational tabletop education displays, each having multiple educational subject matter representations, corresponding to said identified contemporaneous operational stage of the subjects.

12. An education kit for the leveled education progression of a subject, said kit comprising:
a first tabletop education display, having a first educational subject matter representation, corresponding to an identified contemporaneous operational stage of the subject, wherein said first education display includes a pliable body dimensioned to cover an upper surface of a pre-determined table size and a side surface of said pre-determined table size and with a body fabricated of a material adapted to effectively engage digestible matter; and
a second tabletop education display, having a second educational subject matter representation distinct from said first educational subject matter representation of said first tabletop display, corresponding to said identified contemporaneous operational stage of the subject, wherein said second education display includes a second pliable body dimensioned to cover said upper surface of said pre-determined table size and a side surface of said pre-determined table size and said second body is fabricated of said material adapted to effectively engage digestible matter.

13. The kit of claim 12 further comprising a third tabletop education display, having a third educational subject matter representation corresponding to an elevated operational stage of the subject, wherein said third education display includes a third pliable body dimensioned to cover said upper surface of said pre-determined table size and a side surface of said pre-determined table size and said second body is fabricated of said material adapted to effectively engage digestible matter.

14. The kit of claim 12 wherein said identified contemporaneous operational stage is an operational stage selected from a group consisting of:
a preoperational stage characterized by the subject's use of symbols to represent objects;
a concrete operational stage characterized by the subject's use of logical analysis; and
a formal operational stage characterized by the subject's ability to think abstractly.

15. The kit of claim 14 wherein at least one of said first education displays and said second education displays is a distorted educational subject matter representation accommodating multiple view perspectives.
